(19) United States
(12) Patent Application Publication
(10) Pub. No.: US 2020/0229442 A1
(43) Pub. Date: Jul. 23, 2020

(54) ANTIMICROBIAL COMPOSITIONS

(71) Applicant: YORAM TSIVION, CAESARIA (IL)

(72) Inventor: YORAM TSIVION, CAESARIA (IL)

(21) Appl. No.: 16/639,155

(22) PCT Filed: Aug. 16, 2018
(86) PCT No.: PCT/IL2018/050908

§ 371 Date: Feb. 14, 2020

Related U.S. Application Data
(60) Provisional application No. 62/546,598, filed on Aug. 17, 2017.

(51) Int. Cl. A01N 59/20; A01N 55/02; A01N 37/36; A01N 37/44

(52) U.S. Cl. CPC A01N 59/20; A01N 37/44; A01N 37/36; A01N 55/02

(57) ABSTRACT

Compositions for the control of microbial pests containing ions of zinc (Zn⁺⁺) and copper (Cu⁺⁺) solubilized in water, in which at least some of the ions are complexed with at least one ligand. EDTA is always excluded from the composition. If one of the ligands is citric acid, it is used in an amount smaller than the total molarity of both metals used.

### CROSS-REFERENCE TO RELATED APPLICATIONS

The present application claims the benefit of priority to U.S. Provisional Patent Application Ser. No. 62/546,598, filed Aug. 17, 2017, entitled “Antibacterial agents.” The aforementioned application is hereby incorporated herein by reference.

### TECHNICAL FIELD

The present invention generally relates to chemical agents for combating microbial infection on plants, specifically for use in agriculture.

### BACKGROUND ART

In IL patent 97676 compositions including several transition metal with citric acid in water are disclosed serving as effective antifungal agents. In a paper published in 2016, “Field efficacy of a zinc-copper-hydracid of citric acid biocomplex compound to reduce oozing from winter cankers caused by Pseudomonas syringae var. actinidiae to actinidia spp”. Evidence was brought by M. Scortichini (Journal of Plant Pathology (2016), 98 (3), 651-655), showing that a mixture of complexes of copper with citric acid together with zinc complexes (chelates) with citric acid were efficacious against bacterial infection in kiwi (Actinidia deliciosa), the data was further discussed.

It was the purpose of trials to change or improve the effectiveness of the combinations discussed above by altering the complexing agents (ligands)

### BRIEF DESCRIPTION OF THE DRAWINGS

FIG. 1 is a bar chart representing the effect of various ligands on the activity of a mixture of zinc and copper ions on the growth of fungal colonies (Botrytis) in vitro.

FIG. 2 is a bar chart representing the effect of various ligands on the activity of a mixture of zinc and copper ions on the growth of fungal colonies (Fusarium) in vitro.

FIG. 3 is a bar chart representing the effect of various ligands on the activity of a mixture of zinc and copper ions on the growth of fungal colonies (Verticillium) in vitro.

### DISCLOSURE OF THE INVENTION

In accordance with some embodiments of the present invention a combination of copper ions (Cu⁺⁺) and zinc (Zn++) ions solubilized with zero, one or more ligands (chelating agents) in water were added to growth media in vitro to control pests affecting agriculture, bacteria or fungi.

Effect of Different Chelates/Combinations Vis à Vis Bacteria

Chelates were prepared using equimolar amount of total heavy metal ions (Cu⁺⁺+Zn⁺⁺) with the ligand (citric acid or DL malic acid respectively). The ratio of Zn/Cu (by weight) administered to the bacteria was 2:1 (weight per weight) formulated in water using zinc sulfate and copper sulfate as starting material, respectively. The total molarity of ligand was equal to the total molarity of ligand/s except when ligand was absent. The quantity of heavy metals in the preparations was 4% w/w Zn and 2% Cu w/w in water.

Pseudomonas syringae of a Cu resistant strain was grown in vitro in flasks. Several Cu and Zn combinations with or without ligands were applied to colonies grown in respective flasks incubated at identical conditions. respectively The quantity of growth inhibition effectivity was measured.

| | | DL malic acid | Citric acid |
|---|---|---|---|
| | Non chelated | chelate | chelate |
| Effect/relative | ** | ** | * |

It can be seen in this example that the combination of metal chelated with citric acid was least effective.

Pseudomonas avellanae. The quantity of growth inhibition effectivity was measured as in the above case. This time with no differences in effectivity demonstrated between the three treatments.

Xanthomonas arboricola Var juglandis

| | | DL malic acid | Citric acid |
|---|---|---|---|
| | Non chelated | chelate | chelate |
| Effect/relative | * | * | ** |

In this case, the citric acid chelate was most effective

Effect of Different Chelates/Combinations Vis à Vis Fungi

Chelates (complexes) were prepared using equi-molar amount of total heavy metal ions (Cu⁺⁺+Zn⁺⁺) with the ligand (citric acid or DL malic acid and or others). The ratio of Zn/Cu (by weight) administered to the bacteria was always 2:1 (weight per weight) formulated in water using zinc sulfate and copper sulfate as source salts, respectively. The total molarity of ligand was equal to the total molarity of ligand/s. The quantity of heavy metals in the preparations was 4% w/w Zn and 2% Cu w/w in water.

Choice of Ligand/s

In the foregoing description it was taken for granted that a combination of Zn and Cu ions was used as test agents for testing in vitro. The ligands were selected from EDTA (representing strong chelating ligands) or from some organic acids, all of which much weaker chelating ligands as compared to EDTA.

Experimental Setup

In Vitro

Fungal colonies were grown in petri dishes on a substrate with the combination to be tested was included in the substrate.

Colony diameter was measured in cm, as shown in the figures.

Botrytis Trials

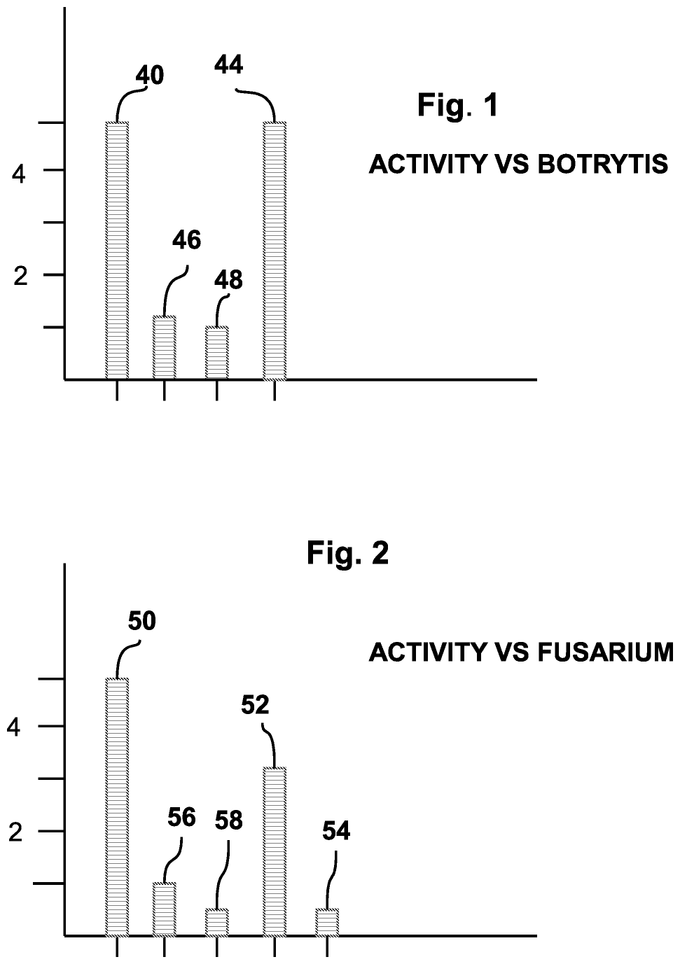

Equal amounts of the test combinations were incorporated into the growth medium at 0.5% in volume. As can be seen in FIG. 1. Column (bar) 40 represents the control dishes, i.e. no test combinations included. The colony diameter reached the diameter of 4.5 cm. Column 44 represents the growth diameter of the colonies in which a test combination including metals and EDTA was used as a ligand in equivalent molar ratio with total molar concentration of both metals used. Column 46 represents the growth in growth medium in which test combination included the metals chelated by citric acid in equi-molar ratio. Column 48 represents the growth of the colony medium included a test combination included the metals chelated with malic acid and citric acid. In this case the total molar concentration of ligands was equal to the total molar concentration of Zn+Cu. And the molar concentration of malic acid was equal to that of citric acid.

Fusarium Trials

Equal amounts of the test combinations were incorporated into the growth medium at 0.5% in volume. As can be seen in FIG. 2. Column (bar) 50 represents the control dishes, i.e. no agent included. The colony diameter reached the diameter of 4.5 cm. Column 52 represents the growth diameter of the colonies in which the test combinations included metals and EDTA as a ligand in equivalent molar ratio with total molar concentration of both metals used. Column 54 represents the growth of the colony in the growth medium included a test combination, the metals (copper and zinc) in which were chelated with lactic acid and citric acid. In this case the total molar concentration of ligands was equal to the total molar concentration of Zn+Cu. And the molar concentration of lactic acid was equal to that of citric acid.

Column 56 represents the growth under the influence of the test combinations the metals of which were chelated by citric acid in equi-molar ratio. Column 58 represents the growth of the colony in the growth medium which included a test combination of which the metals (copper and zinc) were chelated with malic acid and citric acid. In this case the total molar concentration of ligands was equal to the total molar concentration of Zn+Cu. And the molar concentration of malic acid was equal to that of citric acid.

Verticillium Trials

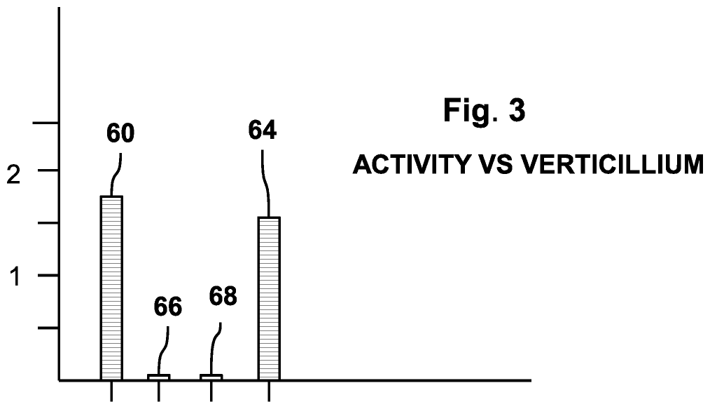

Equal amounts of the test combinations were incorporated into the growth medium at 0.5% in volume. As can be seen in FIG. 3. Column (bar) 60 represents the control dishes, i.e. no agent included. The colony diameter reached the diameter of 1.8 cm. Column 64 represents the growth diameter of the colonies in which a test combination including the metals (copper and zinc) and in which EDTA was used as a ligand in equivalent molar ratio with total molar concentration of both metals used. Column 66 represents the growth as influenceb by a test combination in which the metals were chelated by citric acid in equi-molar ratio. Column 68 represents the growth of the colony in the growth medium in which a test combination was used in whuch the metals were chelated with malic acid and citric acid. In this case the total molar concentration of ligands was equal to the total molar concentration of Zn+Cu. And the molar concentration of malic acid was equal to that of citric acid.

Discussion of the In Vitro Fungal and Bacterial Tests

From the effect EDTA as ligand had on the effectivity of the metals/ligand combination, judging from heretofore described examples, it is not useful to include it in a composition of solubilized ions of zinc and copper intended for use against fungi.

The result that shows better efficacy against a bacterial strain, of non chelated heavy metals ion with respect to citric acid chelates (complexes) of those metal ions used in the trials, can be interpreted such that that a favourable agent should include only partially chelated heavy metals, meaning that the molarity of the ligand or of total ligands is less than the molar concentration of the metals. This way it may be possible to obtain some of the metal ions non chelated and some chelated with the ligand/s of choice. Thus, in such cases it may be possible to gain advantage from the action of non chelated together with the advantageous action of chelated metal ions.

Based on data from “Stability Constants (log K₁) of Various Metal Chelates” disclosed in Chapter 6—Sequestrants in Foods, by Thomas E. Furia, in “CRC handbook of Food Additives”, 2nd ed. 1972. latest revision Oct. 26, 2006 EDTA is by far a strong chelating agent exceeding in affinity to metals the other ligands (organic acids) studied as presented in this disclosure. Also among the chelating agents (ligands) studied, citric acid is a stronger chelating than malic and lactic acid, with regards to Zn and Cu. Based on such data it may seem that any chelation reduces the activity of the heavy metal ions that were studies as desctbed above however the data for the activity against Pseduomonas syringae var syringae (bacterial strain Cu-resistant) suggests that there is no clear cut distinction between non chelated and weakly chelated active metals, and also the strength of chelation may not be taken a priori as indication of the effect on the microbial pests.

Field Studies.

Field studies (not presented) support the theme that replacing at least some of the citric acid in the product containing chelated Cu and Zn used in the field against fungi provides at least a potent control agent as compared to the one in which those metals are exclusively chelated by citric acid.

1. Compositions for the control of microbial pests containing ions of zinc (Zn⁺⁺) and copper (Cu⁺⁺), in which at least some of said ions are complexed with at least one ligand, wherein none of said at least one ligand is EDTA:

2. Compositions as in claim 1, wherein said at least one of said at least one ligand is an organic acid other than citric acid.

3. Compositions for the control of bacterial pests containing solubilized ions of zinc and copper wherein some of said ions are complexed with ligands forming chelates weaker than citric acid chelates.

4. Compositions as in claim 1 wherein one ligand of said at least one ligand is malic acid.

5. Compositions as in claim 1 wherein one ligand of said at least one ligand is malic acid and citric acid.

6. Compositions for the control of microbial pests comprising copper ions and zinc ions with at least one ligand wherein the molarity of total ligands is less than the total molarity of copper plus zinc ions

7. A method for manufacturing compositions the control of bacteria comprising the steps of:
mixing at least Cu and Zn ions, solubilized in water.

8. A method as in claim 7 wherein at least both citric acid and malic acid are further added to said mixture.

9. A method for manufacturing compositions the control of fungi comprising the steps of:
mixing at least Cu and Zn ions, solubilized in water.
